(19) United States
(12) Patent Application Publication
(10) Pub. No.: US 2008/0059252 A1
(43) Pub. Date: Mar. 6, 2008

(54) System and Method for the Allocation of High Demand Properties

(76) Inventors: Timothy Boyer, Denver, CO (US); Brian Corbett, Littleton, CO (US); Tom Filippini, Denver, CO (US); Brad Handler, Palo Alto, CA (US); Brent Handler, Englewood, CA (US); Charles Livingston, Sedalia, CO (US); Ryan Prichard, Boulder, CO (US); Matt Stueve, Denver, CO (US)

Correspondence Address: CERMAK KENEALY & VAIDYA, LLP, 515 EAST BRADDOCK RD SUITE B, Alexandria, VA, 22314, US

(21) Appl. No.: 11/780,032

(22) Filed: Jul. 19, 2007

Related U.S. Application Data
(60) Provisional application No. 60/840,696, filed on Aug. 29, 2006.

(51) Int. Cl. G06Q 10/00

(52) U.S. Cl. 705/5

(57) ABSTRACT

The invention provides a system and method for the equitable and efficient allocation of residences and properties. In accordance with the invention, individuals seeking to reserve high demand properties can first view and select properties and submit a reservation request. The reservation request may include a group of properties by name, preferred reservation dates, as well as a ranking of the individual's highest through lowest property preference.

### CROSS REFERENCE TO RELATED APPLICATION

This application claims priority under 35 U.S.C. 119(e) to U.S. Provisional Application No. 60/840,696 filed on Aug. 29, 2006, the disclosure if which is incorporated herein by reference.

### BACKGROUND OF THE INVENTION

1. Field of the Invention

The invention relates to a system and methods for managing the allocation of properties and residences, and more particularly, to a system and methods for the allocation of high demand properties and residences in an equitable and efficient manner.

2. Discussion of the Related Art

There are a wide class of properties and residences that individuals may seek to purchase, rent or reserve. Individuals can typically find out about available properties through various outlets including the newspaper, through word-of-mouth or through various websites accessible through the internet. For example, individuals can learn about hotel and/or resort vacancies through a hotel's website and can use the website to make reservations. These existing systems for viewing and reserving properties operate efficiently to the extent that there is an adequate supply of properties that can be reserved. However, these systems are not suited for certain high demand properties because such properties are generally available for only a short amount of time.

To address this problem, certain property owners and managers have designated set times when high demand properties may be released for reservation. For example, a hotel manager may release certain high demand suites for rental at 3 pm every Thursday afternoon. Individuals who want to rent the high demand suites must then try to reserve the desired suites at or close to the release time, otherwise they will be quickly booked by others. This system is not unlike those used to offer event tickets and can create frustration among those individuals who are unable to contact the property owner quickly enough to reserve the high demand property before it is reserved by others. This frustration may be even more pronounced among members of residence clubs or other organizations that requires payment of membership fees in order to have access to properties. These members may feel as though they are never able to reserve a high demand property. Thus, there is a need for a system and methods that provide a more equitable and efficient mechanism for offering high demand properties.

### SUMMARY OF THE INVENTION

The invention provides a system and method for the equitable and efficient allocation of residences and properties. In accordance with the invention, individuals seeking to reserve high demand properties can first view and select properties and submit a reservation request. The reservation request may include any number of criteria including a group of properties by name, preferred reservation dates, as well as a ranking of the individual's highest through lowest property preference. The system in accordance with the invention receives all reservation requests during a predetermined time frame for accepting such reservations (“request window”) and then assigns each individual that submitted a request a random number or order. The system then processes all of the individuals who have submitted a reservation request according to their assigned random number or order and tries to fulfill their request. The system examines the individual's first requests to determine whether it can be fulfilled. If it cannot, it goes to the individual's second, third and/or fourth requests until one is located that can be fulfilled. Then it moves to the next individual's requests to determine whether they can be met in order of the individual's most preferred reservation. In this manner, the system goes through each individual's requests until all of the requests have been considered. In one embodiment of the invention, if none of the individual's requests can be met, the system then may locate a comparable residence that is available. In this manner, the system and methods according to the invention consider the reservation requests of every individual who has submitted one or more reservation requests. In addition to allocation of individual properties, the invention can be used to allocate other highly desirable limited supply vacation offerings such as special events, cruises and tours.

High demand properties are allocated in this manner that gives everyone seeking a reservation an equal chance of successfully obtaining the reservation regardless of whether that individual was the first person or the last person to place the reservation request so long as the reservation was received within the predetermined reservation window.

The invention is also applicable to the allocation of properties in a Destination Clubs setting. Destination Clubs allow members to have access to a variety of properties that are part of the Destination Club's portfolio. In such a model, members are particularly desirous of having access to all properties, particularly those that are in high demand, since the members are paying membership fees to have access to the properties. In order to become a member of a Destination Club, an applicant must be screened and approved for membership and pay membership dues. Destination Clubs typically include select properties and may also include amenities related to the property, such as a golf course, private beach and/or spa. Various services may also be associated with the properties, such as housekeeping and concierge services.

### BRIEF DESCRIPTION OF THE DRAWINGS

The accompanying drawings, which are included to provide further understanding of the invention and are incorporated in and constitute a part of this specification, illustrate embodiments of the invention and together with the description serve to explain the principles of the invention. In the drawings:

FIG. 1 shows a block diagram of a system for allocating high demand properties in accordance with an embodiment of the invention;

FIG. 2a illustrates a process leading to the allocation of high demand properties in accordance with an embodiment of the invention;

FIG. 2b illustrates in greater detail a process for allocating high demand properties according to an embodiment of the invention;

FIG. 3 shows a sample timeline for the selection process for members of a Destination Club seeking high demand properties in accordance with one embodiment of the invention;

FIG. 4 illustrates a screen shot for the allocation functionality in accordance with an embodiment of the invention; and

FIG. 5 illustrates a screen shot of an interface provided to a Destination Club member once he or she has completed the reservation request.

### DETAILED DESCRIPTION OF THE PREFERRED EMBODIMENTS

Reference will now be made in detail to various embodiments of the present invention, examples of which are illustrated in the accompanying drawings.

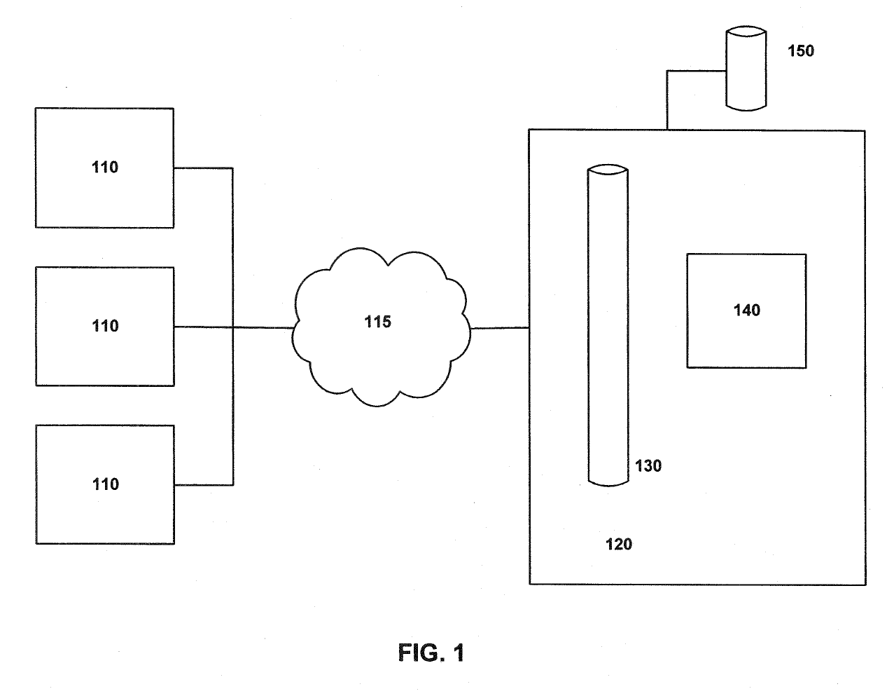

FIG. 1 shows a block diagram of a system for the allocation of properties in accordance with an embodiment of the invention. The term “residences” as used throughout this document is meant to include any type of abode that may be reserved for any given amount of time. Thus, “properties” may include hotel rooms, apartments, vacation homes and/or Destination Club residences. FIG. 1 shows a plurality of users 110 in communication with a residence management server 120 via a communications network 115. The communications network 115 may be any known network, including, but not limited to the Internet, a Local-Area-Network (LAN), or a Virtual Private Network (VPN). The residence management server 120 provides the functionality associated the allocation of properties in accordance with the invention. Such functionality may include, providing information about properties, posting newly available properties, receiving reservation requests and allocating properties based upon the received reservation requests. As shown in FIG. 1, the server 120 may include a webpage application 130 and allocation application 140. The residence management server 120 may also be coupled to a database 150. The residence management server 120 may also include a Read-Only-Memory (ROM), a Random-Access-Memory (RAM), a CPU, a clock and a communications port. These conventional elements are not shown in FIG. 1. The system shown in FIG. 1 allows for the allocation of high demand properties that may be requested by a large number of individuals.

User's 110 will generally refer to individuals or groups seeking to reserve high demand properties. The invention enables users 110 to access, via communications networks, the residence allocation system in accordance with the invention. The users 110 can access the residence management server 120 to view properties, select properties for reservation, rank properties in order of priority and relocate travelers in the event of conflicting reservations. The webpage application 130 provides an interface between the users 110 and the allocation application 140. The database 150 coupled to the residence management server 120 stores information about the properties, including their availability.

The residence management server 120 will likely be maintained by the entity managing the properties. Users 110 can access the application 140 using the webpage application 140 which provides an interface for communications between the users 110 and application 140. The residence management server 120 includes information about each residence. The allocation application 140 includes updated information about newly available properties and is capable of receiving reservation requests as well as a guest's order or ranking of residence preferences.

In operation, a user 110 who may be an individual seeking to reserve a high demand residence may access the webpage application 130 via the communications network 115 in order to gain access to the various functionalities resident on the residence management server 120. For example, the user 110 can, if he or she chooses, first learn about various properties. The user 110 can view a listing of newly available high-demand properties. These listings may be posted by the residence owner/management at their discretion at certain predetermined time intervals. For example, the residence owner/manager may decide to post all newly available high-demand properties at midnight every Tuesday night. The user 110 can begin viewing those newly available high-demand properties at that time. The residence owner/manager can also set a time limit (“request window”) for how long those properties may be available for viewing and requesting a reservation. Thus, a user 110 can view and request a reservation for a high demand property at any time during the request window. The user 110 can select a residence as well as a preferred reservation start date and end date. The user 110 can also make multiple selections and then rank them in order of preference. The user 110 can then submit the selections and preference rankings.

The allocation application 140 may receive reservation requests with rankings from multiple users 110 for as long as the request window remains open. Once the request window closes, the allocation application 140 allocates the properties. In order to make this allocation, the allocation application 140 first assigns each submitting individual with a random number that may be used to determine the order the system will evaluate and grant reservations. Then, starting from the lowest random number and/or the top of the ordered reservation requests, the allocation application 140 determines whether the user's first reservation preference can be fulfilled. If the user's first reservation preference cannot be fulfilled, the allocation application 140 goes to the next preference from the same user to see whether that request can be fulfilled. This process continues until the allocation application 140 is able to make a reservation that fulfills any of the user's reservation requests. If none of the reservation preferences can be met, the next user's requests are examined. In one embodiment of the invention, if an individual's requests cannot be met, the system may suggest certain comparable properties that are available. The allocation application 140 then goes to the next user's reservation requests to see whether any of that user's requested reservations can be fulfilled. This process continues until the allocation application 140 has evaluated each user's reservation requests. Members are then notified whether their reservations requests were fulfilled. This notification can place through various forms, including an e-mail notification.

As described earlier, the system described in connection with FIG. 1 above can be utilized by various residence management companies, including hotels, apartments, vacation homes, cruise lines, timeshares, fractional ownership clubs, private residence clubs and/or Destination Clubs. In the Destination Club model, users 110 may include administrative and sales staff and residence level operations personnel such as concierges who may all assist a member with the reservation process. It should also be noted that in the case of Destination Clubs, the system can also consider the membership tier or level of the requesting member. In this case, higher tier members may be given a preference over other members when determining who is eligible to book a high demand residence.

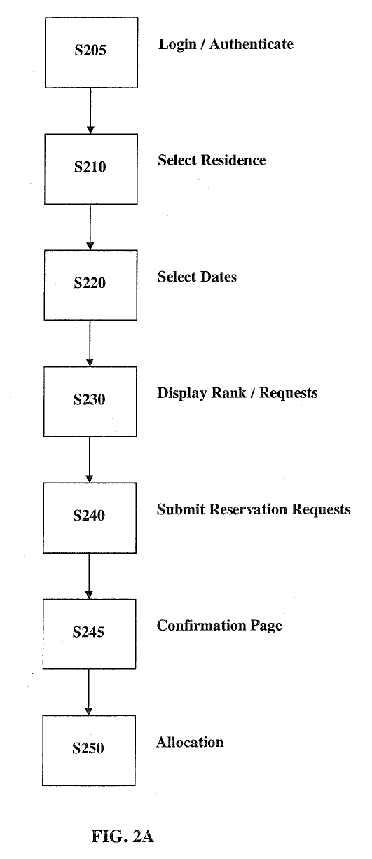

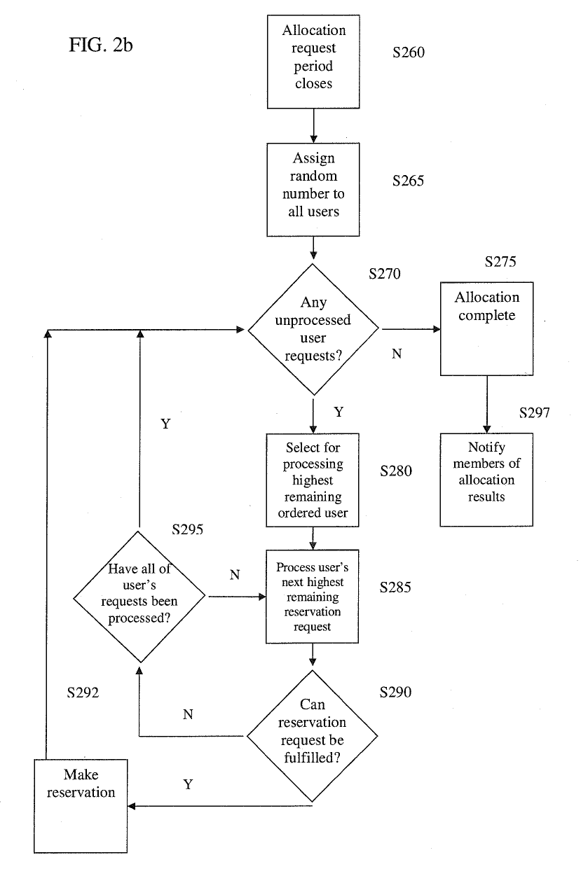

FIG. 2a illustrates a flowchart of a process for allocating properties in accordance with an embodiment of the invention. In FIG. 2a, the process begins with step S205. In step S205, a user accesses the residence management system, logs in, and is authenticated as a registered member. The process then moves to step S210. In step 210, the user can navigate to a page that gives a listing of properties that are included in the particular selection period. The properties are organized in any number of ways, such as, based upon a location or lifestyle offering and a user can select one or more properties that they wish to reserve. According to various embodiments of the invention, the user can select specific properties by name or simply select destination(s) or lifestyle category. The process then moves to step S220. In step S220, the user can select preferred dates for reserving the residence(s) (i.e., arrival and departure dates). The process then moves to step S230.

In step S230, the system displays the user's reservation requests. The user can then rank the reservation selections from highest to lowest. To enhance the user experience, users can drag and drop their requests from one position to another and the system will automatically re-rank the requests according to the user's updated placement. The process then moves to step S240 where the member submits to his or her reservation request ranked as described in S230. The process then moves to S245. In step S245, the system generates a confirmation page that the reservation request has been received. Users may go back to the allocation system and change their reservation requests and rankings until the end of the reservation window. The process then moves to step S250. In step S250, the system allocates the properties defined for the selection period for each of the users who have submitted reservation requests.

FIG. 2b illustrates in greater detail the process for allocating properties described in S250 above in accordance with an embodiment of the invention. The process begins with step S260. In step S260, the system closes the reservation window so that users are prevented from making any further reservation requests or changes to the reservation requests in order for the system to begin allocating properties. The process then moves to step S265.

In step S265, the system takes all of the users who have made a reservation request and assigns a random order to each of the users. The process then moves to step S270. In step S270, system determines whether there are any users whose reservation requests have not been processed. If there are no unprocessed user reservation requests, then the process moves to step S275 where the allocation process is deemed to be completed. After step S275, the process moves to step S297 where the system notifies members of the allocation results. This notification can occur through a variety of methodologies, including, for example, through an electronic mail message or a posting on a secure website. If in step S270 the system determines that are unprocessed user reservation requests, then process moves to step S280.

In step S280, the system selects for processing the highest remaining ordered user based upon the randomization step S265 to see whether his or her reservation request(s) can be fulfilled. The process then moves to step S285. In step S285, the system reviews and attempts to reserve the selected user's most desired reservation (including date and residence). This means that if the user has requested more than one residence for a particular date, in step S285, the system will process the user's first reservation request. The process then moves to step S290 where the system determines whether the user's desired reservation is available. If the desired reservation is available, the process moves to step S292 where the reservation is made. The process then moves to step S270 to determine whether there are any additional unprocessed users who have made a reservation request. If in step S290, the system determines that the user's desired reservation request cannot be made, then the process moves to step S295. In step S295, where the user's reservation request cannot be fulfilled, the system determines whether all of the user's reservation requests have been processed. If they have been processed, the process moves to step S270 to determine whether there are any additional unprocessed users who have made a reservation request. However, if in step S295, all of the user's reservation requests have not been processed, then the process returns to step S285 where the next request is processed. Thus, the system according to the invention processes each user's reservation request(s) until it can fulfill at least one of the user's reservation preferences. If none of a user's requests can be fulfilled, then that user's requests go to the bottom of the order and may be revisited in the event that future vacancies arise. In one embodiment of the invention, the system will offer comparable properties to users whose requests cannot be fulfilled.

In one embodiment of the invention, if the particular selection period was set up to award more than one reservation per user, the process can then continue, starting this time from the user that was last evaluated. If a user has been awarded a reservation and had additional reservation requests that were ranked lower than the reservation they were awarded, the system can award additional reservations if allowed and requested by the user. Users are then notified whether their reservations requests have been fulfilled. This notification can place through various forms, including an e-mail notification.

It is important to note that the allocation functionality can extend beyond high demand properties to other properties or certain time periods. Also, the allocation functionality can be used to allocate other highly desirable limited supply vacation offerings such as special events, cruises and tours. The various parameters of the allocation functionality can also be varied by the property management group. For example, the number of days in which members can view and select high demand properties can be varied.

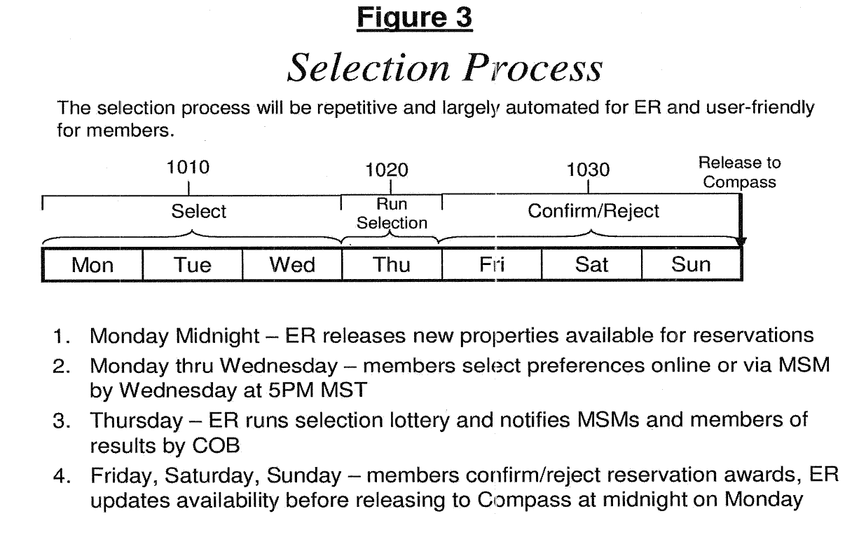

FIG. 3 shows a sample timeline for the selection process for members of a Destination Club seeking high demand properties in accordance with one embodiment of the invention. FIG. 3 shows a time window 1010, which begins on the Selection Begin Date/Time and ends on the Selection End Date/Time. During this time window 1010, members can make reservation requests for properties included in the particular selection period. During the second time 1020, the system allocates the properties according to the process described in S250. The members are notified of the results of the allocation process on the Member Notification Date/Time shown in 1020. During the time window 1030, between the Member Notification Date/Time and the Member Release Date/Time, members may cancel their reservations according to regular cancellation rules. At the Member Release Date/Time, the membership base may reserve available dates via the normal reservation process for the properties defined in the selection period.

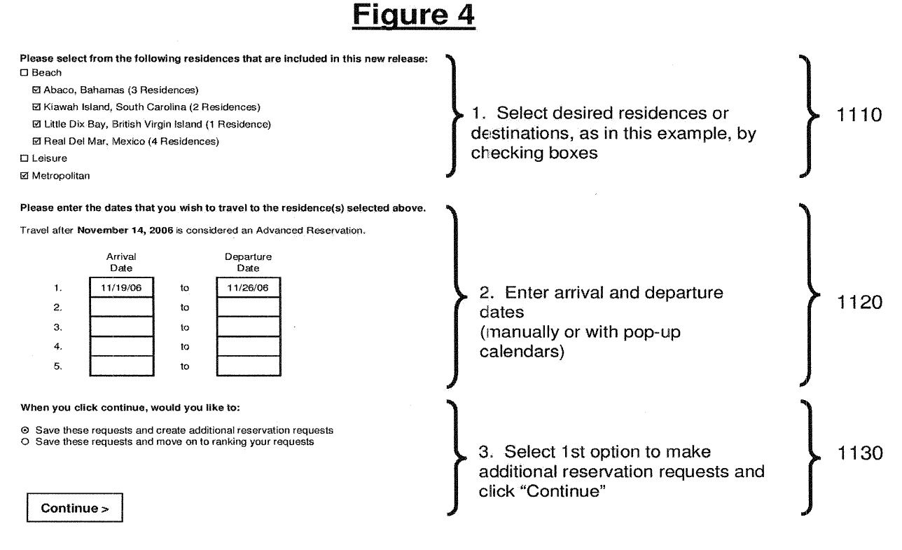

FIG. 4 illustrates a screen shot for the allocation functionality in accordance with an embodiment of the invention. FIG. 4 shows a listing of available properties 1110. The available properties 1110 are grouped by lifestyle (beach, leisure, metropolitan). A member can select one or more desired residence, destination type or travel offering by clicking the box next to the property name. FIG. 4 also includes a travel date area 1120 which allows members to enter their preferred arrival and departure dates. Finally, FIG. 4 includes area 1130 where a member can save his or her selections and create additional requests or can save the requests and move to the next step of ranking the requests. It should be noted that the details provided on the screen shot of FIG. 4 vary depending upon the member's profile.

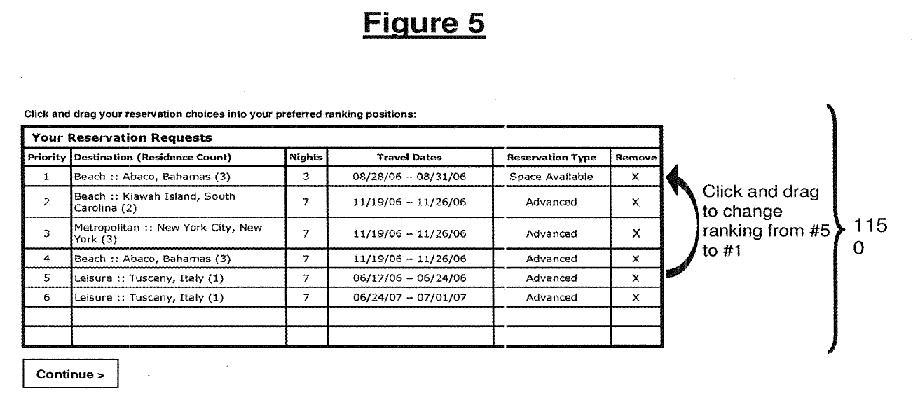

FIG. 5 illustrates a screen shot of an interface provided to a member once he or she has completed the reservation request described above. Area 1150 shown in FIG. 4 is a listing of all of the reservation requests submitted by a member. The member can rank the reservation requests by dragging and dropping each individual request and placing it in the desired order.

It will be apparent to those skilled in the art that various modifications and variations can be made in the present invention without departing from the spirit or scope of the invention. Thus, it is intended that the present invention cover the modifications and variations of this invention provided that they come within the scope of any claims and their equivalents.

1. A method for allocating high demand properties or vacation offerings, comprising the steps of:
receiving a reservation request from a plurality of users, each reservation request including preferred reservation dates, at least one residence or vacation offering selection, and a preference ranking;
randomly ordering participating users from the plurality of users from first to last;
examining the first ordered user request to determine whether at least one of the first ordered user's requests can be fulfilled;
repeating the examination process for each subsequently ordered user request; and
notifying each user to inform them whether the request was fulfilled.

2. The method according to claim 1, wherein the step of examining the first ordered user includes examining the user's request in order of preference ranking.

3. The method according to claim 1, wherein a user is offered a comparable residence or vacation offering if his/her residence selection cannot be fulfilled.

4. The method according to claim 1, wherein the user is the member of a Destination Club.

5. The method according to claim 1, wherein the properties are at least one of a hotel room, an apartment, vacation offering or a Destination Club residence.

6. The method according to claim 1, wherein reservation requests are accepted only during a predetermined reservation request window.

7. The method according to claim 6, wherein the ordering and determining steps occur only after the predetermined request window has closed.

8. A system for allocating high demand properties, comprising:
a plurality of user interface devices;
an allocation application for receiving and processing reservation requests from at least one user interface device, the allocation application including an allocation engine for randomly ordering requestors, examining the ordered user requests to determine whether the requests can be fulfilled; and repeating the examination process for each subsequently ordered user request.
